(19) United States
(12) Patent Application Publication
(10) Pub. No.: US 2013/0080212 A1
(43) Pub. Date: Mar. 28, 2013

(54) METHODS AND SYSTEMS FOR MEASURING ENGAGEMENT EFFECTIVENESS IN ELECTRONIC SOCIAL MEDIA

(71) Applicants: Lei Li, Miami, FL (US); Tong Sun, Penfield, NY (US); Wei Peng, Fremont, CA (US)

(72) Inventors: Lei Li, Miami, FL (US); Tong Sun, Penfield, NY (US); Wei Peng, Fremont, CA (US)

(73) Assignee: XEROX CORPORATION, Norwalk, CT (US)

(21) Appl. No.: 13/245,039

(22) Filed: Sep. 26, 2011

(51) Int. Cl. G06Q 10/00

(52) U.S. Cl. 705/7.38

(57) ABSTRACT

A system and method for measuring engagement effectiveness with respect to a service agent by analyzing a conversation between the agent and a customer in a social media environment. A conversation history between the agent and the customer can be mapped into a multi-resolution space based on different time frames via a mapping module. A polarized topical and sentimental distance between the continuous conversations can be calculated by applying a topic-sentiment mixture model and a divergence theorem onto the conversation history with respect to the time frame. Finally, the polarized topical distances can be aggregated in a time-sensitive way based on a time function and an effectiveness score can be calculated and represented as a weighted pyramid kernel of multiple levels. Such a time-sensitive pyramid kernel function based on the implicit topical and sentimental correspondences between daily conversations enables discriminative evaluation for the agent engagement in a customer care.

### TECHNICAL FIELD

Embodiments are generally related to social network marketing. Embodiments are additionally related to engagement effectiveness measurement techniques. Embodiments are further related to the measurement of engagement effectiveness with respect to service agents in the context of a social media environment.

### BACKGROUND OF THE INVENTION

CRM (Customer Relationship Management) is a widely, implemented strategy for managing a company's interaction with respect to customers, clients, and sales prospects. CRM involves utilizing technology to organize, automate, and synchronize business processes such as sales activities, marketing, customer service, and technical support. The overall goals of CRM include the abilities to find, attract, and win a new client, nurture and retain the existing client, entice former clients back into the fold, and reduce the costs associated with marketing and client services.

Social media generally involves a large number of users who interact socially with one another in an electronic social network environment. In such a paradigm, users can freely express and share opinions with other users via an electronic social networking application. Social media encompasses online media such as, for example, collaborative projects (e.g. Wikipedia), blogs and microblogs (e.g. Twitter), content communities (e.g. YouTube), social networking sites (e.g. Facebook), virtual game worlds (e.g. World of Warcraft), and virtual social worlds (e.g. Second Life). Particularly, online social media can be harvested to share experience/issues with respect to a product, service, brand, and industry.

Customer care in the context of a social customer relationship management arrangement generally involves a product service agent who utilizes commercial social media listening and engagement tools (e.g. Radian6, Sysomos, InvisibleTech, etc.) to respond to a user complaint/issue and assist the user in tackling problems so as to improve the satisfaction of the customer/user. When conversation topics are identified, which relate to a product/service of interest, the product service agent enters the conversation to supply requested information and seeks to address the identified problems. Commercial social media tools in this context only provide aggregated levels of trends, patterns, and sentiment analysis based on keyword-centric brand relevant data, which afford little insights for answering one or more key questions in a social CRM system.

An engagement effectiveness measure quantifies the results and outcomes of the service agent in the social customer relationship management and assists in managing resources effectively. Conventional CRM effectiveness measurement techniques, especially in “Call Center” environments, measure the effectiveness based chiefly on time duration per call and/or the number of answered calls per day and often result in very poor performance metrics. Different from a “Call Center”, online social media involves a great deal of text-oriented interactions between customers and product service agents, which requires much more human labors and is more difficult to analyze. Therefore, the ability to ensure an effective engagement process in the scenario of electronic social media is a critical business requirement.

Based on the foregoing, it is believed that a need exists for improved methods and systems for measuring engagement effectiveness with respect to a service agent in a social media environment, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide an improved customer relationship management effectiveness measurement method and system.

It is another aspect of the disclosed embodiments to provide an improved method and system for measuring engagement effectiveness with respect to a service agent in a social media environment.

It is a further aspect of the disclosed embodiments to provide an improved method and system for computing a time-sensitive pyramid kernel function based on an implicit topical and sentimental correspondence with respect to daily conversations.

The aforementioned aspects and other objectives and advantages can now be achieved as described herein. Methods and systems for measuring engagement effectiveness with respect to a service agent by analyzing a conversation between the agent and a customer in a social media environment are disclosed herein. A conversation history between the agent and the customer can be mapped into a multi-resolution space based on different time frames via a mapping module. A polarized topical and sentimental distance between the continuous conversations can be calculated by applying a topic-sentiment mixture model and a divergence theorem (e.g., modified Kullback-Leibler (KL) divergence) onto the conversation history with respect to the time frame. Finally, the polarized topical distances can be aggregated in a time-sensitive way based on a time function and an effectiveness score can be calculated and represented as a weighted pyramid kernel of multiple levels. Such a time-sensitive pyramid kernel function based on the implicit topical and sentimental correspondences between daily conversations enables discriminative evaluation for the agent engagement in a customer care.

The uniform time frame can be defined and the conversation history can be separated into multiple pieces based on the time frame. The topic sentiment mixture model can be employed to obtain the probabilistic distribution of words (e.g., topic-based distribution, sentiment-based distribution) for each time frame. The modified Kullback-Leibler divergence of the probabilistic distribution of words can be computed by considering social influence of the customer having conservation with the agent for the continuous time frames and the divergences can then be aggregated in a weighted manner. The influence of the customer can be calculated by considering the scale of a personal social network to incorporate the social influence into the measurement of engagement effectiveness.

The modified KL-divergence of the topic-based distribution between the conversations having a small value represents the conversation topics have not changed much. The value of KL-divergence is normalized based on the entire distance space. Note that the sentiment distance is not captured by KL-divergence in the context of the disclosed embodiments. Instead, it is captured by modeling the sentiment changes utilizing the number of positive and negative works, as described in Equation (7) herein. The number of sentiment words whose probabilities are greater than a pre-defined threshold can be counted and then the sentiment change can be quantified. The topical KL-divergence and the sentimental change can then be aggregated in order to capture the topical and sentimental differences simultaneously.

The time function can be defined to determine appropriate time weights for each distance in the order that the recent conversation histories contribute more to the overall effectiveness when aggregating the distances of the multiple continuous time frames. The time function is a monotonic decreasing function, which deduces uniformly with time. The distance between the conversation histories can be hierarchically computed based on different time frames to render the kernel function more flexible. The proposed distance hierarchy provides effectiveness evidence in multiple time granularities in case that a manager tries to investigate and review the engagement effectiveness of the particular time frame. The greater engagement score represents the better engagement performance of the agent. The proposed invention describes a novel time-sensitive metric to measure the effectiveness of social engagement, and the metric comprehensively analyzes the content of conversations between the agent and the customer from topical, sentiment, and social impact perspectives.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including an engagement effectiveness identification module, an operating system, and a user interface, in accordance with the disclosed embodiments;

FIG. 3 illustrates a block diagram of an engagement effectiveness identification system for measuring engagement effectiveness with respect to a service agent, in accordance with the disclosed embodiments;

FIG. 4 illustrates a high level flow chart of operations illustrating logical operational steps of a method for measuring engagement effectiveness with respect to a service agent by analyzing a conversation between the agent and a customer in a social media environment, in accordance with the disclosed embodiments; and

FIG. 5 illustrates a toy example of a multi-resolution distance space, in accordance with the disclosed embodiments.

### DETAILED DESCRIPTION

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network (e.g., WiFi, Wimax, 802.xx, and cellular network) or the connection may be made to an external computer via most third party supported networks (for example, through the Internet using an Internet Service Provider).

The disclosed embodiments are described in part below with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Although not required, the disclosed embodiments will be described in the general context of computer-executable instructions, such as program modules, being executed by a single computer. In most instances, a “module” constitutes a software application. Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by, other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

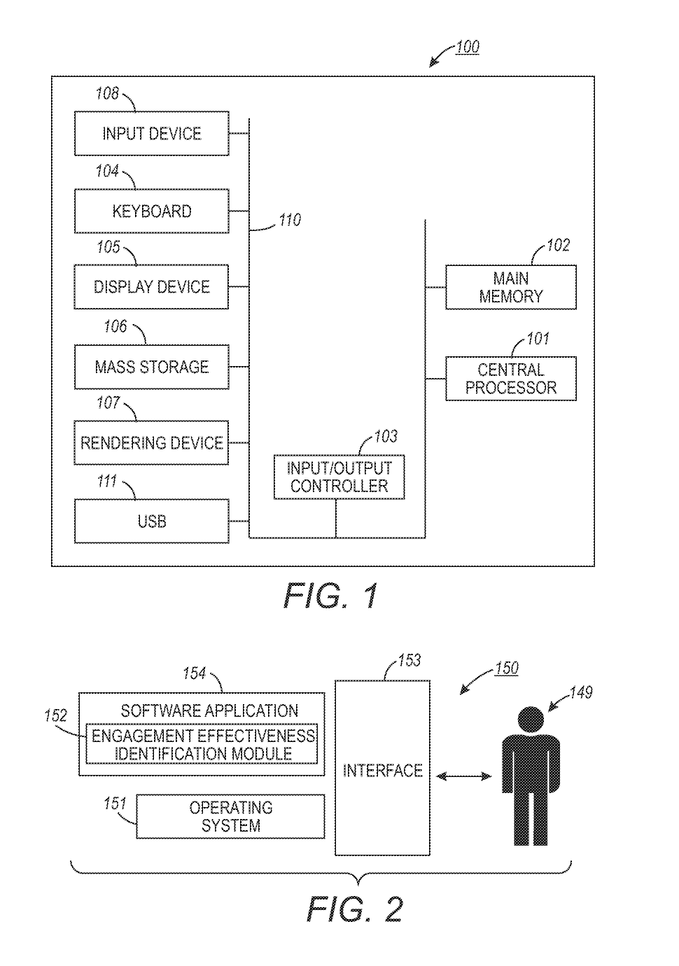

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 108 (e.g., a pointing device such as a mouse, track ball, and pen device, etc.), a display device 106, a mass storage 107 (e.g., a hard disk), and a USB (Universal Serial Bus) peripheral connection 111. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 152, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 154 and/or software application 152.

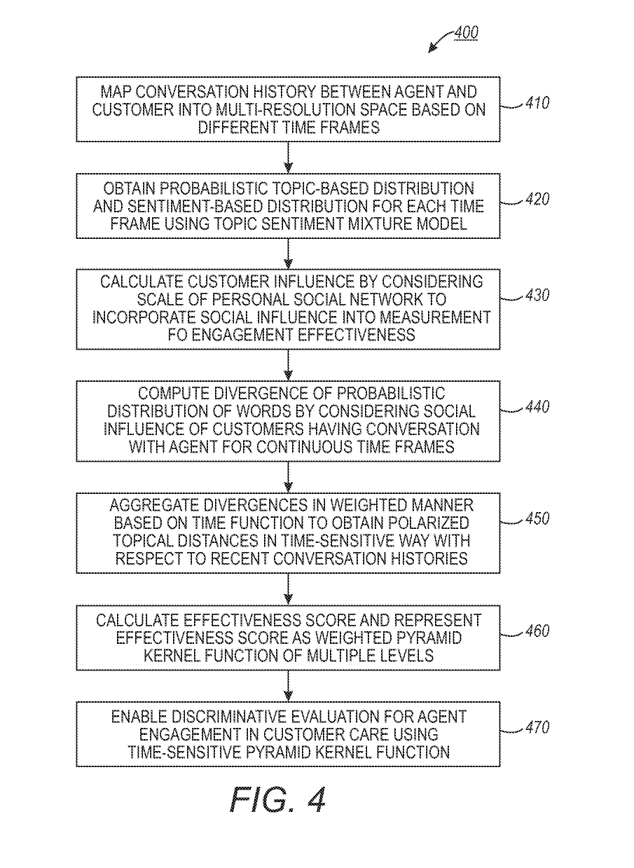

The interface 153 is preferably a graphical user interface (GUI) and generally serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include an engagement effectiveness identification module 152 for measuring engagement effectiveness with respect to a service agent by analyzing a conversation between the agent and a customer in social media environment. Software application 154, on the other hand, can include instructions such as the various operations described herein with respect to the various components and modules described herein such as, for example, the method 400 depicted in FIG. 4.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

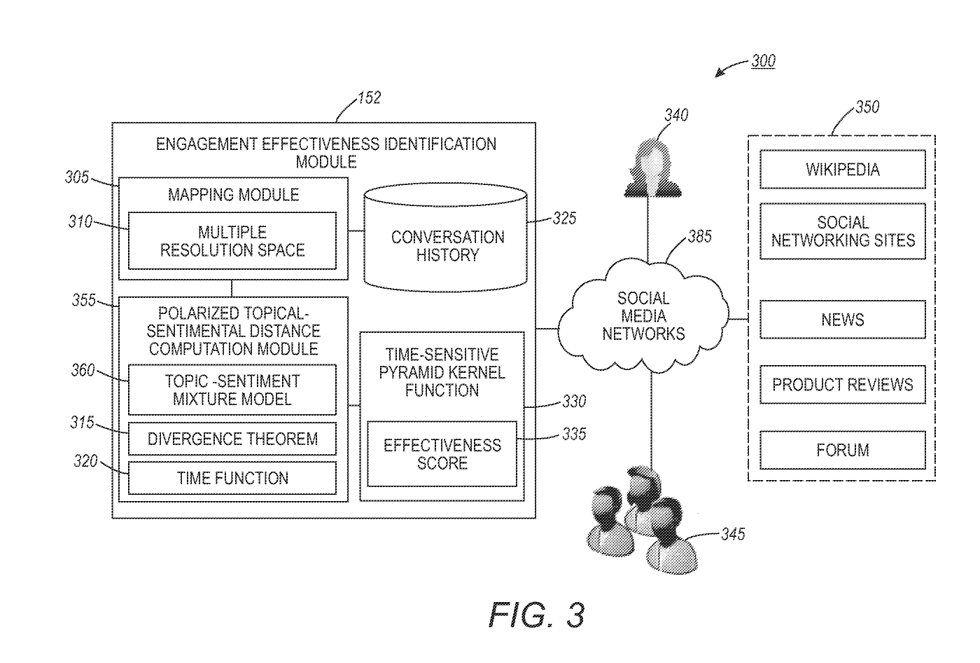

FIG. 3 illustrates a block diagram of an engagement effectiveness identification system 300 for measuring engagement effectiveness with respect to a service agent 340, in accordance with the disclosed embodiments. Note that in FIGS. 1-5, identical parts or elements are generally indicated by identical reference numerals. The social media networks 385 can be configured to include the engagement effectiveness identification module 152 for measuring engagement effectiveness with respect to the service agent 340. The social media networks 385 include social media 350, for example, networks, websites, or computer enabled systems. For example, a social media network may be MySpace, Facebook, Twitter, Linked-In, Spoke, or other similar computer enabled systems or websites. The engagement effectiveness identification module 152 quantifies the extent to which the service agent 340 produces an intended result. For the measurement process, the effectiveness assessment quantifies how well the measurement process provides timely, accurate, and useful information to decision makers.

The engagement effectiveness identification module 152 includes a mapping module 305, a polarized topical/sentimental distance computation module 355, and a time sensitive pyramid kernel function module 330. The mapping module 305 maps a conversation history between the agent 340 and one or more customers 345 into a multi-resolution space 310 based on a time frame. The polarized topical/sentimental distance computation module 355 determines a polarized topical and sentimental distance between the continuous conversations by applying a topic-sentiment mixture model 360 and a divergence theorem 315 onto the conversation history 325 with respect to the time frame. The topic-sentiment mixture model 360 proposes a probabilistic mixture model called topic-sentiment mixture to model and extract the multiple subtopics and sentiments in the conversation history.

Note that the divergence theorem 315 can be, for example, a Kullback-Leibler (KL) divergence which can be modified to determine the polarized topical and sentimental distance to incorporate the social influence into the measurement of engagement effectiveness. In probability theory and information theory, the Kullback-Leibler divergence (also information divergence, information gain, relative entropy, or KLIC) is a non-symmetric measure of the difference between two probability distributions P and Q. KL measures the expected number of extra bits required to code samples from P when using a code based on Q, rather than using a code based on P. Typically P represents the “true” distribution of data, observations, or a precisely calculated theoretical distribution. The measure Q typically represents a theory, model, description, or approximation of P. The Kullback-Leibler (KL) divergence is modified to determine the polarized topical and sentimental distance.

The polarized topical distances can be aggregated in a time-sensitive way based on a time function 320 and an effectiveness score 335 can be calculated and represented as a weighted pyramid kernel function 330 of multiple levels. The time-sensitive pyramid kernel function 330 based on the implicit topical and sentimental correspondences between daily conversations enables discriminative evaluation for the agent engagement in a customer care. Note that the time function 320 can be represented as an exponential form, which is able to describe the gradual decay of the importance of past conversations as time goes. It will be apparent to those skilled in the art that other forms of time function can be utilized as desired without departing from the scope of the invention.

FIG. 4 illustrates a high level flow chart of operations illustrating logical operational steps of a method 400 for measuring engagement effectiveness with respect to the service agent 340 by analyzing a conversation between the agent 340 and the customer 345 in a social media environment 350, in accordance with the disclosed embodiments. Note that the method 400 can be implemented in the context of a computer-useable medium that contains a program product including, for example, a module or group of modules. The conversation history 325 between the agent 340 and the customer 345 can be mapped into multi-resolution space 310 based on a time frame, as indicated at block 410. For example, consider an agent u accompanied with a conversation history D in the social media 350. A uniform time frame T can be defined and the conversation history D can be separated into multiple pieces based on T as illustrated below in equation (1):

D={Dₜ_{₀},Dₜ_{₁}, . . . ,Dₜ_{ₙ}} (1)

wherein t₀ denotes the current time frame. The probabilistic topic-based distribution and sentiment-based distribution for each time frame can be obtained using topic sentiment mixture model 360, as illustrated at block 420. For each time frame tᵢ, i=0, 1, n, the topic sentiment mixture model 360 can be employed to obtain the probabilistic distribution of words in Dₜ, i.e., topic-based distribution: p(w|θ) and sentiment-based distribution: p(w|θ_{P}) and p(w|θ_{N}), where w represents a word, θ represents the topic hidden in texts, and θₚ, θ_{N} denote positive sentiment and negative sentiment, respectively.

The customer influence can be calculated by considering scale of personal social network 385 to incorporate social influence into measurement of engagement effectiveness, as shown at block 430. The divergence of probabilistic distribution of words can be computed by considering the social influence of the customers 345 having a conversation with the agent 340 for continuous time frames, as indicated at block 440. For continuous time frames, e.g., tᵢ and tᵢ₊₁, a modified Kullback-Leibler (KL) divergence of p(w|θ), p(w|θ_{P}) and p(w|θ_{N}) between Dₜ_{ᵢ} and Dₜ_{ᵢ₊₁} can be computed, by considering the social influence of customers 345 that the agent 340 has a conversation with, and then aggregate the divergences in a weighted manner as the distance between D, and denoted as σ(Dₜ_{ᵢ}, Dₜ_{ᵢ₊₁}). The small KL divergence of p(w|θ) between Dₜ_{ᵢ} and Dₜ_{ᵢ₊₁} represents the conversation topics have not changed much. Similarly, the small KL divergence of p(w|θ_{P}) and p(w|θ_{N}) between Dₜ_{ᵢ} and Dₜ_{ᵢ₊₁} indicates barely changed positive or negative sentiment in the conversation.

The divergences can be aggregated in a weighted manner based on time function 320 to obtain polarized topical distances in a time-sensitive way with respect to recent conversation histories, as illustrated at block 450. For example, consider that the recent engagement of agents is more important than the historical engagement, and therefore, the time function ƒ(t) can be employed to aggregate the distances of multiple continuous time frames as the engagement score of the most fine-grained level as indicated in equation (2) as follows:

$${κ}_{0} ( ψ ( u ) ) = {\sum }_{i = 0}^{n - 1} f ( {t}_{i} ) \cdot σ ( {D}_{{t}_{i}} , {D}_{{t}_{i + 1}} ) \qquad ( 2 )$$

When aggregating the distances of multiple continuous time frames, the time function ƒ(t) is defined to determine appropriate time weights for each distance σ(Dₜ_{ᵢ}, Dₜ_{ₜ₊₁}) in the order that the recent conversation histories contribute more to the overall effectiveness. Intuitively, more recent conversations of the agent 340 possess higher weight in the time weighting scheme. Therefore, the time function ƒ(t) is a monotonic decreasing function, which deduces uniformly with time t and the value of the time weight lies in the range [0, 1]. Note that the time function ƒ(t) is an exponential form for the time function, which is able to describe the gradual decay of the importance of past conversations. The time function can be defined by the following equation (3):

θ(t)=e^{-λ·t} (3)

wherein λ represents the profile decay rate and is the inverse of the time frame T that can be employed to divide the conversation history of agents 340 in each level of the multi-resolution space 310. The distance between conversation histories can be hierarchically computed based on different time frames to make the kernel function 330 more flexible. In general, a team manager might be interested in measuring the engagement effectiveness of the agents 340 from different time periods, e.g., per week or per month. The proposed distance hierarchy aims at providing effectiveness evidence in multiple time granularities, so that team managers can easily navigate and review engagement effectiveness in any particular time frame.

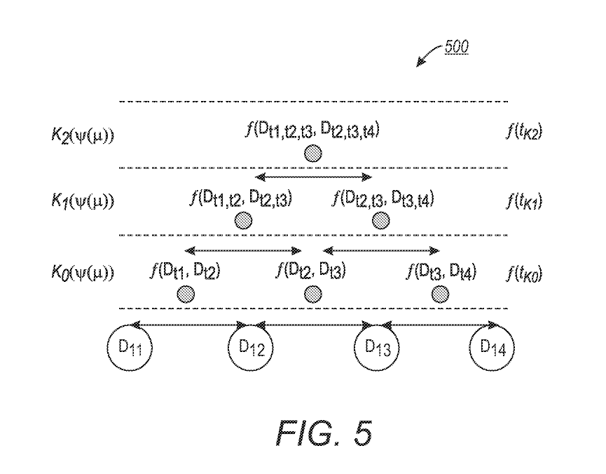

FIG. 5 illustrates a toy example 500 of the multi-resolution distance space. A day can be chosen as the atomic time frame and the distance hierarchy has three layers, as depicted in FIG. 5. Each layer is associated with a time function ƒ(t_{κ}_{ᵢ}), and an effectiveness score 335 of each layer, κᵢ(ψ(u)), can be obtained by aggregating the corresponding distances weighted by θ(t_{κ}_{ᵢ}). The effectiveness score 335 can be calculated and represented as weighted pyramid kernel function 330 of multiple levels, as depicted at block 460. The overall engagement score of agent u can be calculated, as shown in equation (4):

$$κ ( ψ ( u ) ) = {\sum }_{j = 0}^{L} \frac{1}{{2}^{j}} \cdot {κ}_{j} ( ψ ( u ) ) \qquad ( 4 )$$

wherein

$$L = \frac{n ( n + 1 )}{2} ,$$

and κⱼ(ψ(u)) represents the engagement score of level j in the multi-resolution space 310. κ(ψ(u)) is normalized by the number of conversation pairs that are compared by the DL divergence. Thus the engagement score does not favor the conversations within long time frames. The resulted multi-resolution distance space is flexible to navigate in case that the manager tries to investigate the engagement effectiveness of a particular time frame. The greater engagement score means the better engagement performance of the agent.

For example, consider the distance between two continuous time frames from both topical and sentimental perspective. The topics and sentiments of the conversations can be initially quantified in a probabilistic manner, and then the KL-Divergence of topic and sentiment distributions can be calculated. The polarized topical distance can be obtained by aggregating the two KL-Divergences. By applying a topic-sentiment mixture model 360 onto the conversation history of a particular time frame Dₜ_{ᵢ}, we can obtain three different distributions, where one is the topic distribution p(w|θ), denoted as Dₜ_{ᵢ}^{θ}^{ₖ}, and the other two are the sentiment distributions p(w|θ_{P}) and p(w|θ_{N}), denoted as Dₜ_{ᵢ}^{θ}^{_{P}} and Dₜ_{ᵢ}^{θN}, respectively. Traditional KL-Divergence on two probabilistic distributions, e.g., Dₜ_{ᵢ}^{θ} and Dₜ_{ᵢ₊₁}^{θ}, can be computed as shown in equation (5):

$${σ}_{KL} ( {D}_{{t}_{i + 1}}^{θ} , {D}_{{t}_{i}}^{θ} ) = {\sum }_{j} {p}_{{D}_{{t}_{i + 1}}^{θ}} ( {w}_{j} \vert θ ) \cdot log \frac{{p}_{{D}_{{t}_{i + 1}}^{θ}} ( {w}_{j} \vert θ )}{{p}_{{D}_{{t}_{i}}^{θ}} ( {w}_{j} \vert θ )} \qquad ( 5 )$$

wherein θ represents the hidden topic, and wⱼ denotes a word from the conversation text. In a social media scenario, it is imperative to pinpoint the social influence of customers 345 who have conversations with the agents 340, since the opinions of influential customers towards products/brands might diffuse within their personal social networks. To incorporate the social influence into the measurement of engagement effective, the social influence of the customer 345 is measured by considering the scale of the personal social network. Specifically, for a particular word wⱼ, the messages that contain wⱼ and the customers 345 who post these messages can be retrieved, and then the customers' social media profiles can be accessed to evaluate the scale of their social graphs. Hence the equation (5) is modified and can be written as shown in equation (6):

$${\hat{σ}}_{KL} ( {D}_{{t}_{i + 1}}^{θ} , {D}_{{t}_{i}}^{θ} ) = {\sum }_{j} {p}_{{D}_{{t}_{i + 1}}^{θ}} ( {w}_{j} \vert θ ) \cdot log \frac{\vert {U}_{{w}_{j} , {D}_{{t}_{i + 1}}} \vert \cdot {p}_{{D}_{{t}_{i + 1}}^{θ}} ( {w}_{j} \vert θ )}{\vert {U}_{{w}_{j} , {D}_{{t}_{i}}} \vert \cdot {p}_{{D}_{{t}_{i}}^{θ}} ( {w}_{j} \vert θ )} \qquad ( 6 )$$

wherein |U_{w}_{ⱼ}_{,D}ₜ_{₁₊₁}| and |U_{w}_{ⱼ}_{D}ₜ_{ᵢ}| represent the number of users in the social media that might be influenced by customers whose posts contain the word wⱼ. By combining such social impact with the probabilistic distributions, the resulted distance measure (modified KL-Divergence) is more suitable for the social media scenario. Note that the value of KL-Divergence is normalized based on the entire distance space. The modified KL-Divergence is not quite reasonable to be applied to compute the sentimental distance of two continuous time frames, as the sentiment changes in the conversations are concerned. The number of sentiment words whose probabilities, p(w|θ_{P}) or p(w|θ_{N}), are greater than a pre-defined threshold can be counted, and then the sentiment change can be quantified as indicated in equation (7) as follows:

$${σ}_{S} ( {D}_{{t}_{i + 1}} , {D}_{{t}_{i}} ) = \frac{( {W}_{P , {t}_{i + 1}} - {W}_{N , {t}_{i + 1}} ) - ( {W}_{P , {t}_{i}} - {W}_{N , {t}_{i}} )}{{W}_{P , {t}_{i + 1}} + {W}_{N , {t}_{i + 1}} + {W}_{P , {t}_{i}} + {W}_{N , {t}_{i}}} \qquad ( 7 )$$

wherein W_{P,t} represents the number of positive words in the time frame t, and W_{N,t} denotes the number of negative words in t. By using the above equation, the sentimental transformation e.g., from “positive” to “negative”, or from “negative” to “positive”, or from “positive” to “more positive”, can be easily captured. The larger σ_{S} is the more effective the agent is. Note that the sentiment distance is not captured by KL-divergence in the context of the disclosed embodiments. Instead, it is captured by modeling the sentiment changes utilizing the aforementioned number of positive and negative works, as described in Equation (7) above. In order to capture the topical and sentimental differences simultaneously, the topical KL-divergence and the sentimental change can be aggregated as illustrated below in equation (8):

σ(Dₜ_{ᵢ},Dₜ_{ᵢ₊₁})=α·\hat{σ}_{KL}(Dₜ_{ᵢ₊₁}^{θ}^{ₖ},Dₜ_{ᵢ}^{θ}^{ₖ})+(1−α)·σ_{S}(Dₜ_{ᵢ₊₁},Dₜ_{ᵢ}) (8)

As indicated in equation (8) above, the first component captures the topical distance, and the second one aims to investigate the sentimental difference from both positive and negative perspectives. Here, the parameter a controls the importance of topical and sentimental distance in the overall measurement. The discriminative evaluation for agent engagement in customer care can be enabled using time-sensitive pyramid kernel function 330, as indicated at block 470. The proposed invention describes a novel time-sensitive metric to measure the effectiveness of social engagement, where the metric comprehensively analyzes the content of conversations between the agent 340 and the customer 345 from topical, sentiment, and social impact perspectives.

Based on the foregoing, it can be appreciated that a variety of embodiments, preferred and alternative, are disclosed herein. For example, in an embodiment, a method for measuring engagement effectiveness is disclosed. Such a method can include the steps of mapping a conversation history between an agent and at least one customer into a multi-resolution space based on a time frame; determining a polarized topical and sentimental distance between continuous conversations by applying a topic-sentiment mixture model and a divergence theorem to the conversation history with respect to the time frame; and aggregating the polarized topical and sentimental distance in a time-sensitive manner based on a time function in order to thereafter calculate an effectiveness score and represent the effectiveness score as a weighted pyramid kernel function of multiple levels wherein the effectiveness score with a high value is indicative of an enhanced engagement performance by the agent and hence a measure of engagement effectiveness of the agent.

In other embodiments, the aforementioned mapping operation can be implemented as a step for mapping the conversation history between the agent and the at least one customer into the multi-resolution space based on the time frame via a mapping module. In another embodiment, steps can be implemented for defining the time frame and separating the conversation history into the multi-resolution space based on the time frame; obtaining a probabilistic distribution of word for each time frame via the topic sentiment mixture model; and computing a divergence of the probabilistic distribution of word utilizing the divergence theorem by considering a social influence of the customer having a conservation with the agent for the continuous time frame.

In yet another embodiment, the aforementioned probabilistic distribution can comprise a topic-based distribution. In still another embodiment, the aforementioned probabilistic distribution can comprise a sentiment-based distribution. In another embodiment, a step can be implemented for determining the social influence of the customer by considering a scale of a social network. In yet another embodiment, the aforementioned divergence theorem can comprise a modified Kullback-Leibler divergence.

In still other embodiments, a step can be implemented for indicating that the conversation topic remains unchanged for a period of time if the divergence with respect to the topic-based distribution between the conversations results in a small value. In another embodiment, a step can be implemented for indicating a miniscule changed positive sentiment and/or a miniscule change negative sentiment in the conversation if the divergence with respect to the sentiment-based distribution between the conversations results in a small value. In another embodiment, a step can be implemented for normalizing a value of the divergence theorem based on an entire distance space.

In other embodiments, a step can be implemented for counting a plurality of sentiment words if the probabilistic distribution of the plurality of sentiment words is greater than a pre-defined threshold in order to thereafter quantify a sentiment change. In still other embodiments, a step can be implemented for defining the time function to determine an appropriate time weight for each distance so that a recent conversation history contributes more to the engagement effectiveness when aggregating the polarized topical and sentimental distance of the continuous time frame.

In another embodiment, the aforementioned time function can comprise a monotonic decreasing function, which deduces uniformly with time. In other embodiments, a step can be implemented for providing the engagement effectiveness in a plurality of time frames in order to easily navigate and review the engagement effectiveness in any particular time frame among the plurality of time frames.

In another embodiment, a system for measuring engagement effectiveness can be implemented. Such a system can include, for example, a processor, a data bus coupled to the processor, and a computer-usable medium embodying computer code, the computer-usable medium coupled to and/or in communication with the data bus. The computer program code can comprise instructions executable by the processor and configured for: mapping a conversation history between an agent and at least one customer into a multi-resolution space based on a time frame; determining a polarized topical and sentimental distance between continuous conversations by applying a topic-sentiment mixture model and a divergence theorem to the conversation history with respect to the time frame; and aggregating the polarized topical and sentimental distance in a time-sensitive manner based on a time function in order to thereafter calculate an effectiveness score and represent the effectiveness score as a weighted pyramid kernel function of multiple levels wherein the effectiveness score with a high value is indicative of an enhanced engagement performance by the agent and hence a measure of engagement effectiveness of the agent.

In other embodiments, the aforementioned instructions for mapping the conversation history between the agent and the at least one customer into the multi-resolution space based on the time frame can be further configured for mapping the conversation history between the agent and the at least one customer into the multi-resolution space based on the time frame via a mapping module. In another embodiment, such instructions can be further configured for defining the time frame and separating the conversation history into the multi-resolution space based on the time frame; obtaining a probabilistic distribution of word for each time frame via the topic sentiment mixture model; and computing a divergence of the probabilistic distribution of word utilizing the divergence theorem by considering a social influence of the customer having a conservation with the agent for the continuous time frame.

In another embodiment, a processor-readable medium can be provided, which stores code representing instructions to cause a processor to perform a process to measure engagement effectiveness. Such code can be configured to, for example, map a conversation history between an agent and at least one customer into a multi-resolution space based on a time frame; determine a polarized topical and sentimental distance between continuous conversations by applying a topic-sentiment mixture model and a divergence theorem to the conversation history with respect to the time frame; and aggregate the polarized topical and sentimental distance in a time-sensitive manner based on a time function in order to thereafter calculate an effectiveness score and represent the effectiveness score as a weighted pyramid kernel function of multiple levels wherein the effectiveness score with a high value is indicative of an enhanced engagement performance by the agent and hence a measure of engagement effectiveness of the agent.

In other embodiments, for example, the aforementioned probabilistic distribution in the context of a process-readable medium can comprise one or more of the following: a topic-based distribution and a sentiment-based distribution. In still other embodiments, such code can further comprise code to determine the social influence of the customer by considering a scale of a social network and provide the engagement effectiveness in a plurality of time frames in order to easily navigate and review the engagement effectiveness in any particular time frame among the plurality of time frames.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for measuring engagement effectiveness, said method comprising:
mapping by one or more computers a conversation history in electronic social media between an agent and at least one customer into a multi-resolution space based on a time frame;
determining by said one or more computers a polarized topical and sentimental distance between continuous conversations by applying a topic-sentiment mixture model and a divergence theorem to said conversation history with respect to said time frame; and
aggregating by said one or more computers said polarized topical and sentimental distance in a time-sensitive manner based on a time function in order to thereafter calculate an effectiveness score quantifying results of said agent and represent said effectiveness score as a weighted pyramid kernel function of multiple levels wherein said effectiveness score with a high value is indicative of an enhanced engagement performance by said agent and hence a measure of engagement effectiveness of said agent.

2. The method of claim 1 wherein mapping said conversation history between said agent and said at least one customer into said multi-resolution space based on said time frame, further comprises:
mapping said conversation history between said agent and said at least one customer into said multi-resolution space based on said time frame via a mapping module.

3. The method of claim 1 further comprising:
defining said time frame and separating said conversation history into said multi-resolution space based on said time frame;
obtaining a probabilistic distribution of word for each time frame via said topic sentiment mixture model; and
computing a divergence of said probabilistic distribution of word utilizing said divergence theorem by considering a social influence of said at least one customer having a conservation with said agent for said continuous time frame.

4. The method of claim 1 wherein said probabilistic distribution comprises a topic-based distribution.

5. The method of claim 1 wherein said probabilistic distribution comprises a sentiment-based distribution.

6. The method of claim 3 further comprising determining said social influence of said at least one customer by considering a scale of a social network.

7. The method of claim 1 wherein said divergence theorem comprises a modified Kullback-Leibler divergence.

8. The method of claim 3 further comprising indicating that said conversation topic remains unchanged for a period of time if said divergence with respect to said topic-based distribution between said conversations results in a small value.

9. The method of claim 3 further comprising indicating a miniscule changed positive sentiment and/or a miniscule change negative sentiment in said conversation if said divergence with respect to said sentiment-based distribution between said conversations results in a small value.

10. The method of claim 1 further comprising normalizing a value of said divergence theorem based on an entire distance space.

11. The method of claim 1 further comprising counting a plurality of sentiment words if said probabilistic distribution of said plurality of sentiment words is greater than a pre-defined threshold in order to thereafter quantify a sentiment change.

12. The method of claim 1 further comprising defining said time function to determine an appropriate time weight for each distance so that a recent conversation history contributes more to said engagement effectiveness when aggregating said polarized topical and sentimental distance of said continuous time frame.

13. The method of claim 1 wherein said time function comprises a monotonic decreasing function which deduces uniformly with time.

14. The method of claim 1 further comprising providing said engagement effectiveness in a plurality of time frames in order to easily navigate and review said engagement effectiveness in any particular time frame among said plurality of time frames.

15. A system for measuring engagement effectiveness, said system comprising:
a processor;
a data bus coupled to said processor; and
a computer-usable medium embodying computer code, said computer-usable medium being coupled to said data bus, said computer program code comprising instructions executable by said processor and configured for:
mapping a conversation history in electronic social media between an agent and at least one customer into a multi-resolution space based on a time frame;
determining a polarized topical and sentimental distance between continuous conversations by applying a topic-sentiment mixture model and a divergence theorem to said conversation history with respect to said time frame; and
aggregating said polarized topical and sentimental distance in a time-sensitive manner based on a time function in order to thereafter calculate an effectiveness score quantifying results of said agent and represent said effectiveness score as a weighted pyramid kernel function of multiple levels wherein said effectiveness score with a high value is indicative of an enhanced engagement performance by said agent and hence a measure of engagement effectiveness of said agent.

16. The system of claim 15 wherein said instructions for mapping said conversation history between said agent and said at least one customer into said multi-resolution space based on said time frame, are further configured for:
mapping said conversation history between said agent and said at least one customer into said multi-resolution space based on said time frame via a mapping module.

17. The system of claim 15 wherein said instructions are further configured for:
defining said time frame and separating said conversation history into said multi-resolution space based on said time frame;
obtaining a probabilistic distribution of word for each time frame via said topic sentiment mixture model; and
computing a divergence of said probabilistic distribution of word utilizing said divergence theorem by considering a social influence of said at least one customer having conservation with said agent for said continuous time frame.

18. A processor-readable non-transitory medium storing code representing instructions to cause a processor to perform a process to measure engagement effectiveness, said code comprising code to:
map a conversation history in electronic social media between an agent and at least one customer into a multi-resolution space based on a time frame;
determine a polarized topical and sentimental distance between continuous conversations by applying a topic-sentiment mixture model and a divergence theorem to said conversation history with respect to said time frame; and
aggregate said polarized topical and sentimental distance in a time-sensitive manner based on a time function in order to thereafter calculate an effectiveness score quantifying results of said agent and represent said effectiveness score as a weighted pyramid kernel function of multiple levels wherein said effectiveness score with a high value is indicative of an enhanced engagement performance by said agent and hence a measure of engagement effectiveness of said agent.

19. The processor-readable medium of claim 18 wherein said probabilistic distribution comprises at least one of the following: a topic-based distribution and a sentiment-based distribution.

20. The processor-readable medium of claim 18 wherein said code further comprises code to:
determine a social influence of said at least one customer by considering a scale of a social network; and
providing said engagement effectiveness in a plurality of time frames in order to easily navigate and review said engagement effectiveness in any particular time frame among said plurality of time frames.
